(19) United States
(12) Patent Application Publication
(10) Pub. No.: US 2015/0155653 A1
(43) Pub. Date: Jun. 4, 2015

(54) Receptacle connector having interface reinforcement structure

(71) Applicants: Zhudong Huo, Shenzhen (CN); Guofeng Peng, Shenzhen (CN)

(72) Inventors: Zhudong Huo, Shenzhen (CN); Guofeng Peng, Shenzhen (CN)

(21) Appl. No.: 14/311,244

(22) Filed: Jun. 21, 2014

(30) Foreign Application Priority Data
Dec. 2, 2013 (CN) 201320780433.4

(51) Int. Cl. H01R 13/627; H01R 13/6581

(52) U.S. Cl. CPC H01R 13/6271; H01R 13/6581

(57) ABSTRACT

A receptacle connector having an interface reinforcement structure comprises: an insulating body, a conductive terminals group installed inside the insulating body to form an interface, and a shielding shell covering the insulating body, wherein the shielding shell comprises an upper base plate and a lower base plate. A front edge portion of the upper base plate is bended upward and extended to form at least one locking portion with an inverted T shape, which comprises a vertical portion and a horizontal portion. A groove is disposed on an edge portion of a top wall of the insulating body; when the shielding shell covers the insulating body, the vertical portion is installed in the groove to push upward the top wall by the horizontal portion located under the top wall of the insulating body.

### CROSS REFERENCE OF RELATED APPLICATION

The present invention claims priority under 35 U.S.C. 119(a-d) to CN 201320780433.4, filed Dec. 2, 2013.

### BACKGROUND OF THE PRESENT INVENTION

1. Field of Invention

The present invention relates to a receptacle connector, and more particularly to a receptacle connector having interface reinforcement structure matched with a plug connector of flexible flat cable (FFC).

2. Description of Related Arts

A conventional receptacle connector matched with a plug connector of flexible flat cable (FFC) comprises a shielding shell, an insulating body, and a plurality of conductive terminals that are received inside the insulating body; wherein, the insulating body comprises a top wall and a bottom wall, which are arranged parallelly to one the other; and conductive terminals are respectively installed on the top wall and the bottom wall to form an interface, for matching with the FFC plug connector. The shielding shell covers an outer surface of the insulating body, for grounding to shield. In the receptacle connector with conventional structure, the top wall of the insulating body is relatively long and thin, and thus a middle position of the top wall is easy to sag or collapse to deform the interface, which causes that the FFC plug connector cannot be properly matched with the receptacle connector.

### SUMMARY OF THE PRESENT INVENTION

An object of the present invention is to provide a receptacle connector having interface reinforcement structure, for overcoming a problem of a deformation of an interface in conventional structure, that a top wall of an insulating body is easy to sag or collapse to deform the interface.

The object of the present invention is realized by technical schemes that are described as follows.

A receptacle connector having interface reinforcement structure comprises:

an insulating body,

a conductive terminals group installed inside the insulating body to form an interface, and

a shielding shell covers the insulating body;

wherein the shielding shell comprises an upper base plate and a lower base plate,

wherein a front edge portion of the upper base plate of the shielding shell is bended downward and extended to form at least one locking portion having an inverted T shape, which comprises a vertical portion and a horizontal portion; wherein, the vertical portion is formed by the front edge portion extended downward along a longitudinal direction of the interface; and the horizontal portion is formed by a bottom end of the vertical portion extended along a transverse direction of the interface.

A groove coupled with the vertical portion is installed on an edge portion of a top wall of the insulating body. When the shielding shell covers the insulating body, the vertical portion of the locking portion is installed in the groove to push upward the top wall by the horizontal portion located under the top wall of the insulating body.

The horizontal portion comprises a first horizontal portion and a second horizontal portion, which are located respectively on a left side and a right side of the bottom end of the vertical portion.

A stepping portion is installed on one side or two sides of the groove. When the shielding shell covers the insulating body, the horizontal portion of the locking portion resists on the stepping portion to push upward the top wall of the insulating body by the stepping portion.

The stepping portion is in an inverted L shape. Each stepping portion and a lower space of one or two the stepping portions adjacent form an L shaped slot or an inverted T shaped slot, for coupling with the locking portion.

Along the transverse direction of the interface, a width of the vertical portion is wider than a width of the horizontal portion.

The locking portion comprises a bending portion located on an upper end of the vertical portion, which is formed by the front edge portion bended downward for 90 degrees.

An amount of the locking portion is 1, and the locking portion is located on an exactly middle position of the front edge portion of the upper base plate.

Preferably, the amount of the locking portions is M, which is larger than 1. In this condition, the locking portions are distributed on the entire front edge portion of the upper base plate with an uniform or a non-uniform spacing; alternatively, the locking portions are distributed on a middle location of the front edge portion of the upper base plate with the uniform or the non-uniform spacing; alternatively, by centering about a central line of the longitudinal direction of the interface, all of the locking portions are distributed evenly and symmetrically.

Comparing the present invention to the conventional technology, beneficial effects are described as follows.

In an embodiment of the present invention, by additionally installing a locking structure on a shielding shell, a top wall of an insulating body is supported, for preventing the top wall of the insulating body to sag or even collapse; and even if the top wall of the insulating body sags and even collapses, the top wall of the insulating body is supported by the shielding shell, for preventing a deformation of an interface and guaranteeing that the FFC plug connector can be properly matched with the receptacle connector and a stable electrical connection.

These and other objectives, features, and advantages of the present invention will become apparent from the following detailed description, the accompanying drawings, and the appended claims.

### BRIEF DESCRIPTION OF THE DRAWINGS

FIG. 1 is an exploded perspective view of a receptacle connector according to a preferred embodiment of the present invention.

FIG. 2 is a perspective view of the receptacle connector according to the preferred embodiment of the present invention.

FIG. 3 is a top view of the receptacle connector according to the preferred embodiment of the present invention.

FIG. 4 is a bottom view of the receptacle connector according to the preferred embodiment of the present invention.

FIG. 5 is a side view of the receptacle connector and a partially enlarged view of a locking portion according to the preferred embodiment of the present invention.

FIG. 6 is a sectional view of the receptacle connector along an A-A line shown in FIG. 5 and the partially enlarged view of the locking portion.

### DETAILED DESCRIPTION OF THE PREFERRED EMBODIMENT

In order to make an object, technical schemes, and advantages of the present invention to be relatively clear and understandable, referring to drawings and an embodiment, the present invention is further described in details. Understandably, the embodiment described is only applied to explain the present invention, but is not applied to limit the present invention.

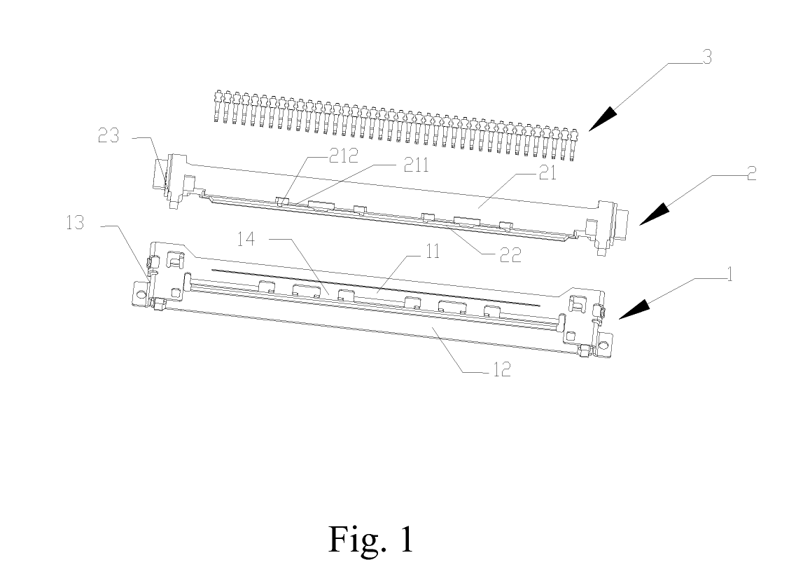

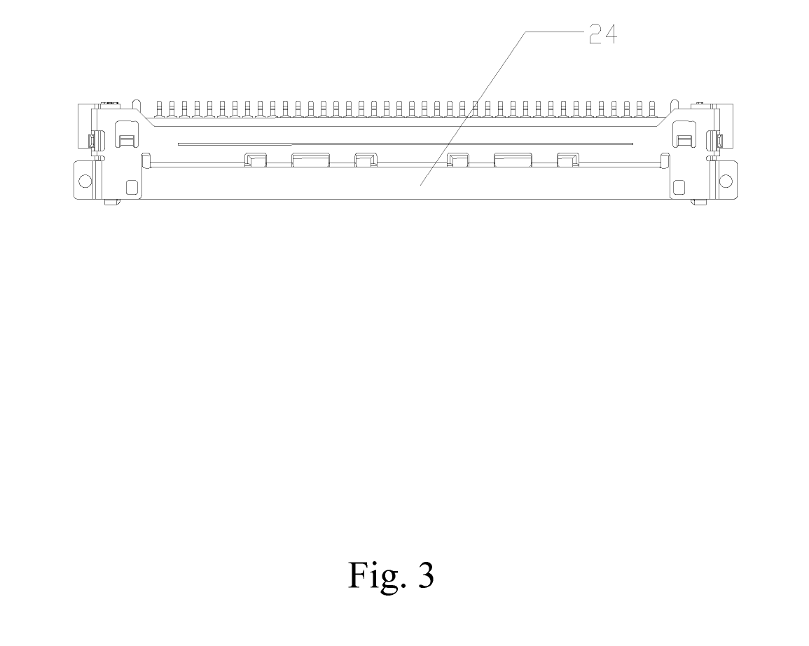

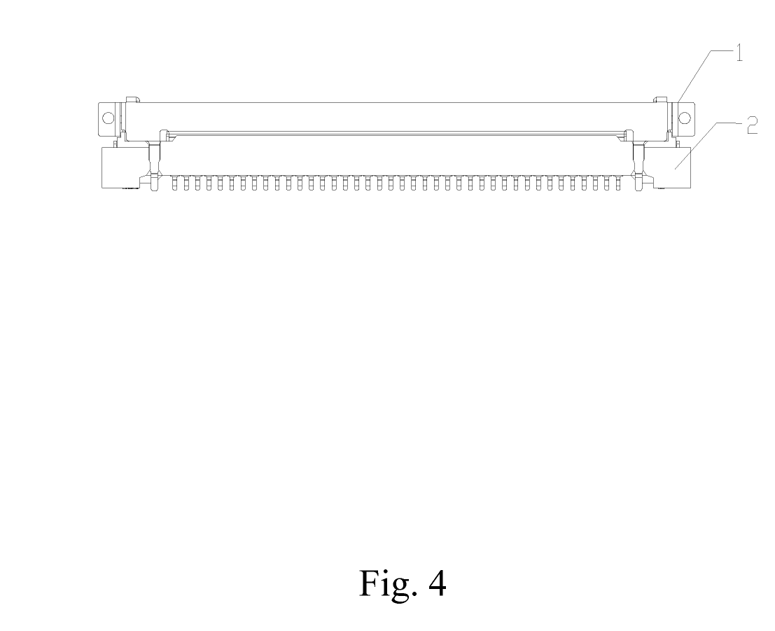

A receptacle connector of the present invention is provided for coupling with an LVDS plug connector, which is connected by a Flexible Flat Cable (FFC). Referring to FIG. 1 to FIG. 4, the receptacle connector comprises a shielding shell 1, an insulating body 2, and a conductive terminals group 3.

The insulating body 2 comprises a top wall 21, a bottom wall 22, and two side walls 23. The conductive terminals group 3 is installed between the top wall 21 and the bottom wall 22 to form an interface 24.

The shielding shell 1 comprises an upper base plate 11, an lower base plate 12, and two side plates 13. The shielding shell 1 covers the insulating body 2 so that the upper base plate 11 and the lower base plate 12 are respectively contacted to an upper surface and a lower surface of the insulating body 2, for covering the insulating body 2 as well as protecting and shielding signals.

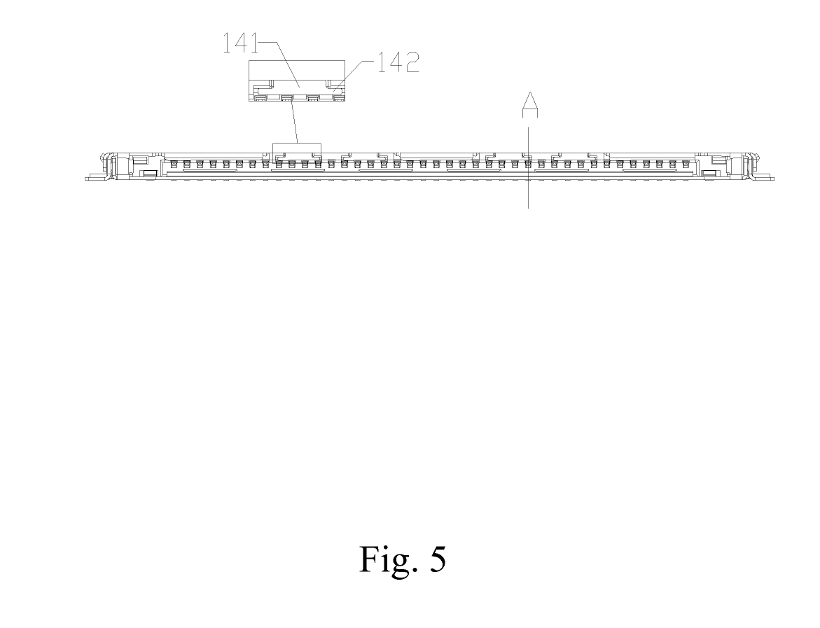

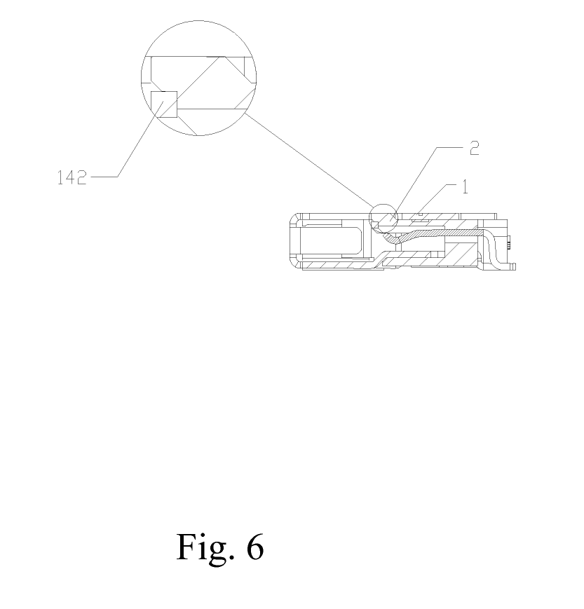

In an preferred embodiment, as shown in FIGS. 1, 2, 5, and 6, for preventing that the top wall 21 of the insulating body 2 sags or collapses to deform the interface 24, a front edge portion of the upper base plate 11 of the shielding shell 1 is bended downward and extended to form a plurality of locking portions 14 with an inverted T shape, and the locking portion 14 is formed by a bending portion 143, a vertical portion 141, and a horizontal portion 142 from top to bottom in order, which are integrally formed; wherein, the bending portion 143 is formed by the front edge portion of the upper base plate 11 bended downward for 90 degrees; the vertical portion 141 is formed by a bottom end of the bending portion 143 extended downward along a longitudinal direction of the interface 24; the horizontal portion 142 is formed by a bottom end of the vertical portion 141 extended along a transverse direction of the interface 24; wherein the horizontal portion 142 comprises a first horizontal portion and a second horizontal portion that are respectively located on a left side and a right side of the bottom end of the vertical portion 141. A plurality of grooves 211 are disposed on an edge portion of the top wall 21 of the insulating body 2, an amount and a location of the grooves 211 are coupled to the amount and the location of the locking portions 14, for installing the vertical portion 141 of the locking portion 14.

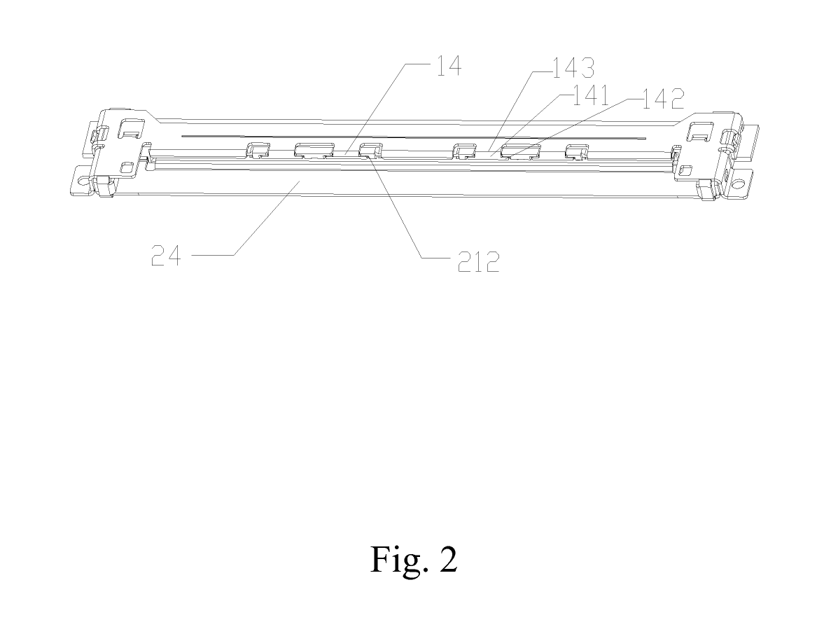

As shown in FIG. 2, when the shielding shell 1 covers the insulating body 2, the vertical portion 141 of the locking portion 14 is installed in the groove 211; two ends of the horizontal portion 142 are located under the top wall 21 of the insulating body 2, and are contacted to the top wall 21; when a middle location of the top wall 21 sags or collapses, the two ends of the horizontal portion 142 apply an upward supporting force to the top wall 21, for preventing deforming the interface 24. The amount of the locking portions 14 is not limited, and a spacing distance to one another thereof is also not limited, so the locking portions 14 can be disposed on the entire front edge portion of the upper base plate 11 of the shielding shell 1 with an uniform spacing, and can also be disposed on a middle location of the front edge portion of the upper base plate 11 with a small amount of distribution; preferably, as shown in FIG. 1, two locking portions 14 are respectively disposed on two sides of a central position of the front edge portion of the upper base plate 11 of the shielding shell 1. The locking portion 14 can also be in an L shape, and an action principle of the L shape entirely equals to the action principle of the inverted T shape, which is not further described in details.

In the preferred embodiment, referring to FIGS. 1, 4, and 5, for better cooperating the locking portion 14 to complete supporting the top wall 21 of the insulating body 2, stepping portions 212 are disposed on the edge portion of the top wall 21 of the insulating body 2 and two sides of the groove 211; wherein the stepping portions 212 are in an inverted L shape; the groove and a lower space of the two stepping portions 212 adjacent form an inverted T shaped slot, for coupling with the locking portion 14. When the shielding shell 1 covers the insulating body 2, the vertical portion 141 and the horizontal portion 142 of the locking portion 14 are both installed in the inverted T shaped slot, and two sides of the horizontal 142 push respectively and upward the stepping portion 212 to stably support the top wall 21 of the insulating 2 by the upper base plate 11 of the shielding shell 1, for preventing that the top wall 21 of the shielding shell 1 collapses easily, and a reliability of an electrical connection can be guaranteed. In addition, for guaranteeing a firmness, the vertical portion 141 of the locking portion 14 needs a wider width, which, preferably, is not smaller than a half of a length of the horizontal portion 142.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A receptacle connector having an interface reinforcement structure, comprising:
an insulating body,
a conductive terminals groupinstalled inside said insulating body to form an interface, and
a shielding shell that covers said insulating body;
wherein said shielding shell comprises an upper base plate and a lower base plate;
wherein a front edge portion of said upper base plate of said shielding shell is bended downward and extended to form at least one locking portion with an inverted T shape, which comprises a vertical portion and a horizontal portion, wherein said vertical portion is formed by said front edge portion extended downward along a longitudinal direction of said interface, and said horizontal portion is formed by a bottom end of said vertical portion extended along a transverse direction of said interface;
wherein a groove coupled with said vertical portion is disposed on an edge portion of a top wall of said insulating body; when said shielding shell covers said insulating body, said vertical portion of said locking portion is installed in said groove to push upward said top wall by said horizontal portion located under said top wall of said insulating body.

2. The receptacle connector having the interface reinforcement structure, as recited in claim 1, wherein said horizontal portion comprises a first horizontal portion and a second horizontal portion respectively located on a left side and a right side of said bottom end of said vertical portion.

3. The receptacle connector having the interface reinforcement structure, as recited in claim 1, wherein a stepping portion is disposed on one side or two sides of said groove; when said shielding shell covers said insulating body, said horizontal portion of said locking portion resists on said stepping portion to push upward said top wall of said insulating body by said stepping portion.

4. The receptacle connector having the interface reinforcement structure, as recited in claim 2, wherein a stepping portion is disposed on one side or two sides of said groove; when said shielding shell covers said insulating body, said horizontal portion of said locking portion resists on said stepping portion to push upward said top wall of said insulating body by said stepping portion.

5. The receptacle connector having the interface reinforcement structure, as recited in claim 3, wherein said stepping portion is in an inverted L shape; each said stepping portion and a lower space of one or two said stepping portions form an L shaped slot or an inverted T shaped slot, for coupling with said locking portion.

6. The receptacle connector having the interface reinforcement structure, as recited in claim 4, wherein said stepping portion is in an inverted L shape; each said stepping portion and a lower space of one or two said stepping portions form an L shaped slot or an inverted T shaped slot, for coupling with said locking portion.

7. The receptacle connector having the interface reinforcement structure, as recited in claim 1, wherein along said transverse direction of said interface, a width of said vertical portion is wider than a width of said horizontal portion.

8. The receptacle connector having the interface reinforcement structure, as recited in claim 1, wherein said locking portion comprises a bending portion located on an upper end of said vertical portion, which is formed by said front edge portion bended downward for 90 degrees.

9. The receptacle connector having the interface reinforcement structure, as recited in claim 1, wherein an amount of said locking portion is 1, and said locking portion is located on an exactly middle position of said front edge portion of said upper base plate.

10. The receptacle connector having the interface reinforcement structure, as recited in claim 1, wherein an amount of said locking portion is M, which is larger than 1.

11. The receptacle connector having the interface reinforcement structure, as recited in claim 10, wherein said locking portion is distributed on said entire front edge portion of said upper base plate with a spacing.

12. The receptacle connector having the interface reinforcement structure, as recited in claim 10, wherein said locking portion is distributed on a middle location of said front edge portion of said upper base plate with a spacing.

13. The receptacle connector having the interface reinforcement structure, as recited in claim 11, wherein said locking portion is distributed on said entire front edge portion of said upper base plate with an uniform spacing.

14. The receptacle connector having the interface reinforcement structure, as recited in claim 5, wherein said locking portion is distributed on a middle location of said front edge portion of said upper base plate with an uniform spacing.

15. The receptacle connector having the interface reinforcement structure, as recited in claim 6, wherein said locking portion is distributed on a middle location of said front edge portion of said upper base plate with an uniform spacing.

16. The receptacle connector having the interface reinforcement structure, as recited in claim 11, wherein by centering about a central line of said longitudinal direction of said interface, all of said locking portions are distributed evenly and symmetrically.

17. The receptacle connector having the interface reinforcement structure, as recited in claim 12, wherein by centering about a central line of said longitudinal direction of said interface, all of said locking portions are distributed evenly and symmetrically.
